(19) United States
(12) Patent Application Publication
(10) Pub. No.: US 2012/0011491 A1
(43) Pub. Date: Jan. 12, 2012

(54) EFFICIENT RECORDING AND REPLAYING OF THE EXECUTION PATH OF A COMPUTER PROGRAM

(76) Inventor: Adi Eldar, Kiryat-Ono (IL)

(21) Appl. No.: 12/830,451

(22) Filed: Jul. 6, 2010

(51) Int. Cl. G06F 9/44; G06F 9/445

(52) U.S. Cl. 717/130; 717/174

(57) ABSTRACT

To monitor the execution path of executable code, only non-deterministic jump instructions of the executable code are instrumented by replacing them with respective recording instructions that record the results of executions of the non-deterministic jump instructions and then emulate those executions, thereby providing instrumented code, and the instrumented code is executed. Preferably, the recording instructions are one byte long and invoke an interrupt service routine that does the recording and the emulating. Optionally, selected instructions of the executable code are replaced with trigger instructions for turning the recording on and off. Preferably, after the instrumented code is executed, the addresses of the instrumented instructions and the results of their executions are played back either forward or backward. Optionally, the instrumented code is executed a second time and the results of the executions of the instrumented instructions in the two executions of the instrumented code are compared.

### FIELD AND BACKGROUND OF THE INVENTION

The present invention relates to monitoring the execution of computer program and, more particularly, to a method of recording the execution path of a computer program, for example for debugging.

There are many reasons to record and replay the execution path of a running process: debugging of hard to reproduce problems, regression testing, execution auditing etc.

Recording (in real time) of the execution path of a computer program is a challenging task. As the computer's CPUs execute the thread's instructions at a huge rate (in the order of 10⁹ machine instructions/second in a standard off-the-shelf PC), the recording task needs significant CPU time and a huge amount of storage to save the ordered list of the instruction addresses along the execution path. The large performance and resource penalty of the straightforward approach to execution path recording renders impractical this approach for recording.

### SUMMARY OF THE INVENTION

The current invention defines a method of fully recording the execution path of any (or all) running thread(s) of a process, thus enabling full and precise off-line replay (i.e. review) of all executed instructions in the same order that they executed in real time. The recording is done with minimal performance penalty and storage consumption. The recording is done in the lowest level of specific CPU machine instructions. Any program written in a high level language (such as C, C++, C# etc.) is compiled and linked to generate the machine language executable. During the compilation and linking process a debugging information file is generated. The debugging information enables cross reference between the symbols and addresses in the high-level language (i.e. function and variable names, source file/line number etc.) and the machine language (in memory) addresses. Assuming that the debugging information is available during replay of program execution, the replay can be displayed in the context of the original (high level) programming language.

As will be further described, the present invention successfully solves the real time recording problems noted above by:

a) Analyzing the program machine instructions and adding recording code only for instructions that are critical to the execution flow.

b) The added recording code is highly optimized and captures the minimum data needed to enable off line replay at a later time. Consequently its performance penalty is relatively low.

Therefore, according to the present invention there is provided a method of monitoring an execution path of executable code that includes at least one non-deterministic jump instruction, including the steps of: (a) storing the executable code in a first machine-readable medium; (b) only for each non-deterministic jump instruction of at least a portion of the at least one non-deterministic jump instruction: (i) identifying an address of the each non-deterministic jump instruction, and (ii) replacing the each non-deterministic jump instruction with a respective recording instruction for (A) recording a result of each execution of the each non-deterministic jump instruction in a second machine-readable medium, and (B) emulating the each execution of the each non-deterministic jump instruction, thereby providing instrumented executable code; and (c) effecting a first execution of the instrumented executable code.

Furthermore, according to the present invention there is provided a computer-readable storage medium having computer-readable code embodied on the computer-readable storage medium, the computer-readable code for monitoring an execution path of executable code that includes at least one non-deterministic jump instruction, the computer-readable code including: (a) program code for: only for each non-deterministic jump instruction of at least a portion of the at least one non-deterministic jump instruction: (i) identifying an address of the each non-deterministic jump instruction; and (ii) replacing the each non-deterministic jump instruction with a respective recording instruction for: (A) recording a result of each execution of the each non-deterministic jump instruction, and (B) emulating the each execution of the each non-deterministic jump instruction.

In a basic embodiment of the method of the present invention, the executable code whose execution path is to be monitored is stored in a first machine-readable medium. The addresses of at least some, if not all, of the non-deterministic jump instructions of the executable code are identified and those non-deterministic jump instructions are replaced with respective recording instructions. Only non-deterministic jump instructions are replaced with respective recording instructions, in order to economize on the amount of information recorded in order to replay the execution path. No other kinds of instructions are replaced with respective recording instructions. The recording instruction that replaces a given non-deterministic jump instruction has two functions: to record, in a second machine-readable medium, the result of the execution of the non-deterministic jump instruction, i.e., an indication of the destination address that the non-deterministic jump instruction would have branched to when executed if that non-deterministic jump instruction had not been replaced by the recording instruction, and to emulate that execution (i.e., to branch to that instruction: this branching is only “emulating” of the replaced non-deterministic jump instruction because it is performed by the recording instruction and not by the non-deterministic jump instruction that has been replaced). These replacements transform the executable code into instrumented executable code. Finally, the instrumented executable code is executed.

The identifying of the addresses of the non-deterministic jump instructions and replacing of the non-deterministic jump instructions with the recording instructions is effected either off-line or on-line.

Preferably, all the recording instructions are only one byte long.

In some embodiments of the method, the identifying of the addresses of the non-deterministic jump instructions includes reading an assembly file of the executable code. In other embodiments of the method, the identifying of the is addresses of the non-deterministic jump instructions includes disassembling the executable code, preferably on-line.

In some embodiments of the method, the first and second machine-readable media are the same medium. For example, if the identifying and replacing steps are effected off-line on executable code stored on a hard disk, the results of the executions of the non-deterministic jump instructions may be recorded on the same hard disk. Another example of the first and second machine-readable media being the same medium is an on-line example in which both the executable code and the results of the executions of the non-deterministic jump instructions are recorded in the same random-access memory. In other embodiments of the method, the first and second machine-readable media are different media. For example, the identifying and replacing steps may be effected off-line on executable code that has been loaded onto a hard disk, while the results of the executions of the non-deterministic jump instructions are recorded on-line on a random access memory.

Preferably, the recording of the results of the executions of the non-deterministic jump instructions and the emulations of the execution of the non-deterministic jump instructions are effected by an interrupt service routine that is invoked by the recording instructions. In these embodiments, the recording instructions are software interrupts that invoke the interrupt service routine. Most preferably, the method includes installing the interrupt service routine, for example using a device driver.

Preferably, before the instrumented executable code is executed, a recording structure is set up in the second machine-readable medium. The recording structure includes, for each non-deterministic jump instruction that has been replaced by a recording instruction, the address of the non-deterministic jump instruction and two pointers. The first pointer is to a buffer in the second machine-readable medium for recording the results of the (emulated) executions of the non-deterministic jump instruction. The second pointer points to a code stub that emulates the executions of the non-deterministic jump instruction. The recording of the results of the executions of the non-deterministic jump instructions and the emulating of the executions of the non-deterministic jump instructions are effected with reference to the recording structure.

Preferably, one or more other instructions of the executable code are replaced with trigger instructions. A “trigger instruction” is a software interrupt that turns recording of the destination addresses on or off, most preferably by invoking an appropriate interrupt service routine. Trigger instructions are different from what are termed herein “recording instructions” that do the actual recording of the results of the executions of the non-deterministic jump instructions followed by the emulations of the executions of the non-deterministic jump instructions. Most preferably, the instructions of the executable code that are replaced by trigger instructions are entry points and/or exit points of functions of the executable code.

Preferably, after the instrumented executable code has been executed, the addresses of the non-deterministic jump instructions that were instrumented and the results of their executions (for those instrumented non-deterministic jump instructions that actually were executed) are recorded in a third machine-readable medium, thereby providing a record of the execution path. In some embodiments of the method, the second and third machine-readable media are the same medium. For example, if the identifying and replacing steps are effected off-line on executable code stored on a hard disk and the results of the executions of the non-deterministic jump instructions are recorded on the same hard disk, the record of the execution path may be recorded on the same hard disk. An example of all three machine-readable media being the same medium is an on-line example in which the executable code, the results of the executions of the non-deterministic jump instructions and the record of the execution path all are recorded on the same random-access memory. In other embodiments of the method, the second and third machine-readable media are different media. For example, the results of the executions of the non-deterministic jump instructions may be recorded on a hard disk while the record of the execution path is recorded on an external medium such as a flash disk.

More preferably, the method includes playing the record of the execution path forward or backward. Most preferably, during the forward playing of the execution path, a backward recording array and a backward replay state vector are recorded. The backward playing of the execution path then is in accordance with the backward recording array and the backward replay state vector.

Also more preferably, with the record of the execution path now in hand, the instrumented executable code is executed a second time.

In an off-line embodiment, the addresses of the instrumented non-deterministic jump instructions and the results of their executions (for those instrumented non-deterministic jump instructions that actually were executed) are recorded in a fourth machine-readable medium, thereby providing a second record of the execution path. The third and fourth machine-readable media may or may not be to the same medium. The two records of the execution path are compared. If the two records are different, the point at which they start to differ from each other may be diagnostic of a non-deterministic bug in the executable code. Most preferably, a synchronization instruction is inserted, in the executable code, for recording, in the first and second records of the execution path, every arrival of the two executions at the location in the executable code where the synchronization instruction has been inserted. The point at which the two records start to differ after the synchronization instruction has been reached the same predetermined number of times in the two executions may be diagnostic of a non-deterministic bug in the executable code.

In an on-line embodiment, the result(s) of the execution(s) of the instrumented non-deterministic jump instruction(s) during the second execution are compared with the corresponding result(s) in the first record of the execution path. Most preferably, the second execution is stopped as soon as the comparing shows a difference between the first and second executions in the result of (one of) the execution(s) of (one of) the instrumented non-deterministic jump instruction(s), again because such a divergence of the two executions may be diagnostic of a non-deterministic bug in the executable code. Stopping the execution at this point enables the user to switch over to manual debugging to try to find the non-deterministic bug. Also most preferably, a synchronization instruction is inserted in the executable code. During that first execution, the synchronization instruction records, in the first record of the execution path, every arrival of the first execution at the location in the executable code where the synchronization instruction has been inserted. During the second execution, the synchronization instruction counts the arrivals of the second execution at the location in the executable code where the synchronization instruction has been inserted. After the arrival count reaches a pre-determined number, the result(s) of the execution(s) of the instrumented non-deterministic jump instruction(s) are compared with the corresponding result(s) in the first record of the execution path, and the second execution is stopped as soon as the comparing shows a difference between the first and second executions in the results of (one of) the execution(s) of (one of) the instrumented non-deterministic jump instruction(s), again because such a divergence of the two executions, subsequent to the pre-determined number of arrivals at the location of the synchronization instruction, may be diagnostic of a non-deterministic bug in the executable code. Stopping the execution at this point enables the user to switch over to manual debugging to try to find the non-deterministic bug.

A basic embodiment of a computer-readable storage medium of the present invention has embodied thereon program code for implementing the basic method of the present invention. Other embodiments of the computer-readable storage medium have embodied thereon more program code, for example, program code for the interrupt service routine, program code for the device driver, program code for setting up the recording structure, program code for replacing selected instructions of the executable code with trigger instructions, program code for recording the addresses of the instrumented non-deterministic jump instructions and the results of the executed instrumented non-deterministic jump instructions to provide a record of the execution path, program code for playing the record of the execution path forward, program code for playing the record of the execution path backward, program code for constructing the backward recording array and the backward replay state vector, program code for comparing two records of respective execution paths of two executions of the instrumented code, and/or program code for replacing selected instructions of the executable code with synchronization instructions.

### BRIEF DESCRIPTION OF THE DRAWINGS

Various embodiments are herein described, by way of example only, with reference to the accompanying drawings, wherein:

FIG. 1 shows a C++ program that is used in FIGS. 2-7 to illustrate the present invention;

FIG. 2 shows the program of FIG. 1 as compiled;

FIG. 3 shows how the code of FIG. 2 is instrumented;

FIG. 4 shows the ISR that is used to monitor the execution path of the code of FIG. 1;

FIG. 5 shows the ComJump routine that the ISR calls to interrogate the recording structure;

FIG. 6 shows the CalcJmp stub that is used to record the destination addresses of the conditional branches of the code of FIG. 1;

FIG. 7 shows the jmpDst stub that is used to emulate the conditional branches of the code of FIG. 1;

FIG. 8 is a high level partial block diagram of a computer system set up to debug executable code;

FIG. 9 shows details of the code of FIG. 8 for recording the execution path;

FIG. 10 shows details of the code of FIG. 8 for replaying the execution path.

### DESCRIPTION OF THE PREFERRED EMBODIMENTS

The principles and operation of execution path recording according to the present invention may be better understood with reference to the drawings and the accompanying description.

A program executable file is loaded into the computer memory by the Operating System (OS) loader and starts running in the context of one or more threads of a process. The process is executed from its starting address (which is defined in the program executable file) up to a normal/abnormal exit or until terminated manually. The present invention defines an efficient method for monitoring and recording the sequence of the executed instructions. This method is implemented by a monitoring program that controls the execution of the recorded program based on the following steps:

a) Loading the program into memory and creating its process in suspend mode

b) Finding the set of the recording points (their addresses in the process memory)

c) Instrumentation of the original code at the addresses of the recording points

d) Loading the recording procedure and registering it as an Interrupt Service Routine (ISR)

e) Initializing and updating the recording buffer

f) Resuming the process and collecting the recorded data

g) Upon process termination (or some other event) saving the recorded data

The details of each step now will be described in detail.

### a) Loading the Program into Memory and Creating its Process is Suspend Mode

This step is a standard and a well-known one in order to prepare the code for instrumentation before execution. Code instrumentation is defined as external modification of the program code not via modification of its source code and compilation of a new executable, but rather by directly modifying the machine instructions in the binary executable. Instrumentation techniques are well known in the industry for many years and are regularly used for hooking, profiling, debugging etc. of computer programs. Code instrumentation can be done either by modifying the program executable file (off-line instrumentation) or by modifying the program code after it is loaded into the new process memory (on-line instrumentation). During standard program launch (e.g. when a user double clicks a program icon in Windows™), the OS loader creates a new process, reads the program executable file, arranges the program executable file as required in the process memory and finally schedules the new process for execution. However, in case we want to perform online instrumentation before start of execution we can instruct the OS loader to create the process in suspend mode. In this case the loader performs all of the loading and arranging steps as before, but when the process is ready for execution the loader doesn't schedule the process for execution but instead returns control to its parent process (the process that called the process creation function for the new program). The parent process can then instrument the new suspended process as needed, as is known in the art, and then release the instrumented process from suspend mode by calling a system call telling the OS to schedule the instrumented process for execution.

### b) Finding the Set of the Recording Points

Now, with the new process ready for instrumentation for recording, we need to find the minimal set of machine instructions that must be instrumented in order to be able to accurately replay the execution path. In general, the machine instructions are executed by the CPU in a sequential manner, one after the other. However, there is a subset of machine instructions that alter the common sequential execution by jumping (also known as “branching”) to another code address in the process memory and continuing the sequential execution from the machine instruction at that address. This subset can be further divided to two groups: a group that includes all of the deterministic branching instructions and another group that includes all of the non-deterministic (conditional) jump instructions. A non-deterministic jump instruction is defined as any machine instruction where the decision of whether to execute the jump or not (i.e. whether to continue sequentially), as well as the jump's destination address, depend upon the current thread context. The thread context in turn is defined as the values of the CPU registers and the process memory signature. So based on those definitions we can partition the set of the machine instructions to three subsets:

1 sequential instructions e.g. (on Intel x86 processors) ADD, MOV, PUSH, POP etc.

2. deterministic jump instructions e.g. (on Intel x86 processors) JMP, direct CALL etc.

3. non-deterministic jump instructions e.g. (on Intel x86 processors) JA, JB, JC, . . . , (various conditional jumps) indirect CALL, indirect JMP, RET etc. As noted above, a non-deterministic jump instruction is defined herein as a machine instruction that modifies the sequential control of program flow based on the CPU context.

In order to record the execution flow and in order to be able to completely reproduce the execution flow, we only need to record the result of the third subset, the non-deterministic jump instructions. So at this step we need to locate and to save in memory the addresses of all the machine instructions of the third subset. As in the general case the instruction length of the CPU is not fixed (for example on an Intel x86 CPU it can vary between 1 byte and 15 bytes), we must decipher the code in the process memory to the correct machine instructions stream. This is done by either reading an assembly file of the program (if we compile the program ourselves we can get the assembly file easily as a byproduct of the compilation phase) or by performing real time disassembly of the program code in the process memory. Once we have the disassembled instruction stream we can easily identify the non-deterministic jump instructions and save their addresses for the next step of instrumentation.

### c) Instrumentation of the Original Code at the Addresses of the Recording Points

The instrumentation method is done by the following steps:

1. Replacing the original instruction by a one-byte software recording instruction. Preferably, the recording instruction is implemented as a software interrupt. In principle, the recording instruction could be implemented as another single instruction or sequence of instructions.

2. When the software interrupt is executed the CPU saves its context (registers, stack, flags, return address etc.) and jumps to an Interrupt Service routine (ISR) that is in a predefined location in the system memory.

3. We install a specific ISR that actually executes the recording task. As the ISR is a core component of the invention, its details will be described in the next section. Note that as the system memory is protected in most modern operating systems (like Windows™, Linux™ or Mac OSX™), installation of our ISR is done using a device driver that can access system memory and register our ISR.

4. The ISR has all the information it needs to perform the recording task from the saved context. Once the ISR is done recording, the ISR executes the original instruction (that was overwritten by the recording instruction) and then jumps back to the original destination of the instrumented instruction.

To summarize, this technique enables transparent probing of the running process at the critical non-deterministic points, logging their outcome and continue normal execution.

It is preferable to replace the non-deterministic jump instructions by a one byte software recording instruction (unlike the standard interrupt instructions which are two bytes long on an Intel x86 processor) for the following reason. As some of the standard machine instructions are one byte long (e.g. PUSH, POP, RET etc. on x86), we would like to instrument only those instructions and avoid overwriting the following one. So we need to replace them by an interrupt which is one byte long. This is because in case we overwrite the instruction that follows the non-deterministic one, there is a small chance that a destination of a jump instruction from some other place in the process would be directly to the instruction that follows the instrumented (one byte) instruction address, and in this case neither the interrupt service routine nor the original instruction would be executed. In this case we would end up with a corrupted process, running out of its normal flow. Actually in our case, where we instrument only the non-deterministic jump instructions, almost all of these instructions are two bytes long or longer; the only exception is the standard RET instruction. So we can instrument all but the RET instruction with either one-byte or two-byte interrupts. The specific one-byte interrupt we use is CPU architecture dependent. For example, in x86 architecture, interrupt #3 is the preferred one, as it's a one-byte instruction (0xCC) that is regularly used by standard debuggers for instrumenting of breakpoints in a running process. Therefore we can easily exploit this instruction for our purpose.

### d) Loading the Recording Procedure and Registering it as an ISR

The recording technique records the results (i.e. the destination addresses) of the non-deterministic jump instructions every time that the process executes any instruction of this pre-defined set. The recording procedure described herein is very efficient with minimal impact on both the performance and the storage. During the initialization phase, the recording procedure allocates and initializes, in memory, a recording structure with a recording entry per each instrumented instruction. The main fields of this structure are:

1. The original address of the instrumented instruction. As this address will be used as a lookup key for the recording data of the specific instruction, the array is sorted according to this field.

2. A pointer to a dynamic (variable length) compressed buffer for recording the results of the specific instruction. The structure of this recording buffer and the compression scheme are described in the next section.

3. A pointer to a short code stub that contains the original instruction (that was overwritten with the recording instruction during the instrumentation phase) and conditional jumps to the destinations of the original instruction. After recording the instruction result we jump to this stub and the execution continues just as it would have had we not instrumented the code at all.

The nature of the stub depends on the instruction that the stub emulates, as follows.

Conditional jump instructions need custom-built stubs. Each conditional jump instruction has two possible destination addresses: the instruction following the conditional jump instruction in case the jump is not taken, and the target of the jump in case the jump is taken. In case the jump is taken, it is straightforward to compute the absolute address of the target of the jump. So the stub executes the original instruction and then, depending on the outcome of the execution of the instruction, executes a non-conditional branch either to the instruction following the conditional jump instruction or to the target of the jump.

If the instruction that the stub emulates is an indirect jump or a return, then the destination address depends only on the contents of a specific CPU register. Because the contents of all registers are preserved (see sub-section c) above), such instructions are emulated by generic stubs that depend on the nature of the original instruction but not on the address of the original instruction.

In order to register the recording procedure as an ISR, we need to modify the global IDT (Interrupt Descriptor Table) for all the CPUs of the machine. In a protected operating system the IDT can be written only from kernel mode (also known as ring 0) and cannot be written from user mode. For this reason we use a simple device driver that registers the ISR on demand.

When the TSR is called, from the instrumented machine instructions, the processor switches to privileged (kernel) mode and the user stack is switched to the kernel stack. The original (user mode) return address, the flags register and the user stack registers (stack segment and stack pointer) are saved on the kernel stack. The ISR performs the following steps:

1. Save the general purpose registers on the active (kernel) stack.

2. Modify the user mode stack by pushing a new return (from the interrupt) address to the user mode stack. The new return address is to the recording procedure. Note that the original return address is kept on the user stack just after the new return address.

3. Restore the general purpose registers.

4. Returns from the interrupt (using standard IRET on Intel x86).

Now we are back in user mode code, and due to the way the user mode stack was modified in step 2 we return to the recording procedure. Note that at this point the original return address is on top of the stack, and the state of the flags register is just as it was before the interrupt occurred. So the recording procedure has all the data that is needed for recording: the address of the source non-deterministic jump instruction can be easily retrieved from the return address (which is on top of the stack) by subtracting the one-byte fixed length of the recording instruction itself, and the expected result of this non-deterministic jump instruction can be determined from the flags or from other CPU registers. The recording procedure performs the following steps:

1. Save the general purpose registers and the flags on the (user) stack.

2. Retrieve the original return address and calculate the source address.

3. Search (using binary search or other efficient algorithm) for the specific entry in the sorted recording array and keep a pointer to the specific entry.

4. Modify the return address (on the stack) to point to the address of the code stub of the specific entry.

5. Based on the relevant register (for conditional jumps, this register is the flags register) and the source address of the original non-deterministic jump instruction, log the result of executing the non-deterministic jump instruction in the dynamic recording buffer of the specific entry. The “result” of executing the non-deterministic jump instruction is an indication of which of the possible addresses, that the instruction could jump to, the instruction actually jumped to. Examples of such “results” are discussed in the next section.

6. Return from the recording procedure to the small stub.

7. Now we are in the stub with the original values in the CPU registers; all that is left to be done in the stub is to execute the original instruction (that was instrumented) and (if the instrumented instruction was a conditional jump) based on its result to unconditionally jump to the correct address in the monitored process and continue seamlessly the normal execution of the thread.

### e) Initializing and Updating the Recording Buffer

In order to minimize the monitoring process resource penalty (storage and processing time) the recording buffer must be compact and its update procedure should be very efficient. These requirements are achieved by a dynamic run length encoding as described first for conditional jumps (which are the most common non-deterministic jump instructions) and then for the other types of non-deterministic jump instructions.

Looking the behavior of conditional jumps, we note that in most of the cases there are continuous sequences of executing or not executing the jump. For example, in case we have a “for loop” with 1000 iterations there will be 1000 consecutive times where the conditional jump is not executed followed by one final time when the conditional jump is executed when the program exits the loop. Eventually this sequence can be efficiently compressed by the well-known run length encoding, where we encode 2 “runs”. each “run” represents a single sequence and can be encoded in a short (2 byte) integer for a total of 4 bytes (for the two runs), or in a long (4 byte) integer for a total of 8 bytes. In our case we encode (1000, 1) where the first number is for the 1000 iterations and the second one is for the last single iteration. Note that in this encoding for conditional jumps, where there are only two known destinations, the interpretation of a new run is toggling the destination of the jump result, i.e. if the first run represents the number of consecutive times that the conditional jump was not executed then the second run represents the number of times the conditional jump was executed and so on.

The previous example was very simple as there were only two runs. In real life there might be many more sequences of executing or not executing the conditional jump, and we don't know in advance how many sequences we are going to have per specific conditional jump during the monitored session. On one hand, the conditional jump might not be reached at all during this specific session, and on the other hand, the conditional jump might be reached many times and (in the worst case) generate many short runs. So we cannot pre-allocate a fixed number of runs per the specific instruction's recording buffer and we must let each instruction's buffer grow dynamically as needed. This is achieved by the following algorithm:
Initially we allocate a global buffer of adequate size to be shared by the runs of all non-deterministic jump instructions; still we do not allocate any storage from the global buffer per specific instruction.
The first time that a non-deterministic jump instruction is executed, we allocate a buffer segment to store two runs.
In case more runs are needed, we allocate each time a new buffer segment of runs whose size is twice the number of runs of the previous allocated segment (i.e. 4, 8, 16, . . . ).
Each time that a new buffer segment of runs is allocated we set pointers connecting the new segment to the previous segment and vice versa.
Note that the length of the maximum run that can be stored in a short (2 bytes) integer is less than 65536. In case a specific run is longer than this, for example a “for loop” with 100,000 iterations, we split this run into several runs as needed. In order to keep the same structure of the recording buffer, to where each run toggles the destination of the jump result, we insert a dummy 0 run between the split parts of the long run, so in our example a “for loop” of 100,000 iterations would be encoded as (65535, 0, 34465, 1) and the interpretation is just like (100000, 1). Another option is to encode each run in a long (4 byte) integer; in this case we can encode runs whose length is up to about 4×10⁹ without splitting, at the expense of wasting unused bytes for short runs.

Extension of this scheme to other non-deterministic jump instructions is straight forward. The main difference between conditional jumps and other non-deterministic jump instructions is that for conditional jumps there are only two known destinations: either executing the jump to a fixed target address or not executing and continuing to the next address. So we don't need to encode the destination address and we can assume that a new run toggles the destination address. If we need to encode other non-deterministic jump instructions, such as indirect jumps and returns from functions, we keep the run length encoding but we prefix each new run with the destination address that is represented by this run. This encoding has additional penalty of 4/8 bytes (for 32/64 bit addressing respectively) per each run. If we prefer some extra processing in order to save storage we can build an address table that includes addresses of all possible destinations and then encode only the index into this table for each run.

To summarize, as required, the described scheme is storage- and performance-efficient and adapts quickly to the different behavior of each non deterministic jump instruction.

### f) Resuming the Process and Collecting the Recorded Data

Once the above framework is set, we tell the operating system to release the process and let it run. As described, the results of all the (instrumented) non-deterministic jump instructions are collected and are saved in the recording buffer array in the process memory. In general this data collection continues until the execution is terminated, either normally or abnormally (due to a controlled exit or non-controlled exception). An alternative option to further reduce the performance and storage penalty is to start/stop collecting the data based on specific triggers in the program. These controlling triggers can be implemented by an instrumentation, similar to the recording instrumentation, of the instructions at the required locations to start/stop the recording. For example, if we want to record only the execution path of a specific function we can instrument its entry point to start recording, and its exit point to stop recording, etc.

### g) Upon Process Termination (or Some Other Event) Saving the Recorded Data

Once we have finished recording due to normal/abnormal termination of the process or alternatively due to a ‘stop recording’ trigger, we save the recording array on persistent storage. Thus we further compress the recording buffers of each of the structure entries and save per each entry the original address and its recording buffer in a track file that is the starting point for replay of the execution path as described below.

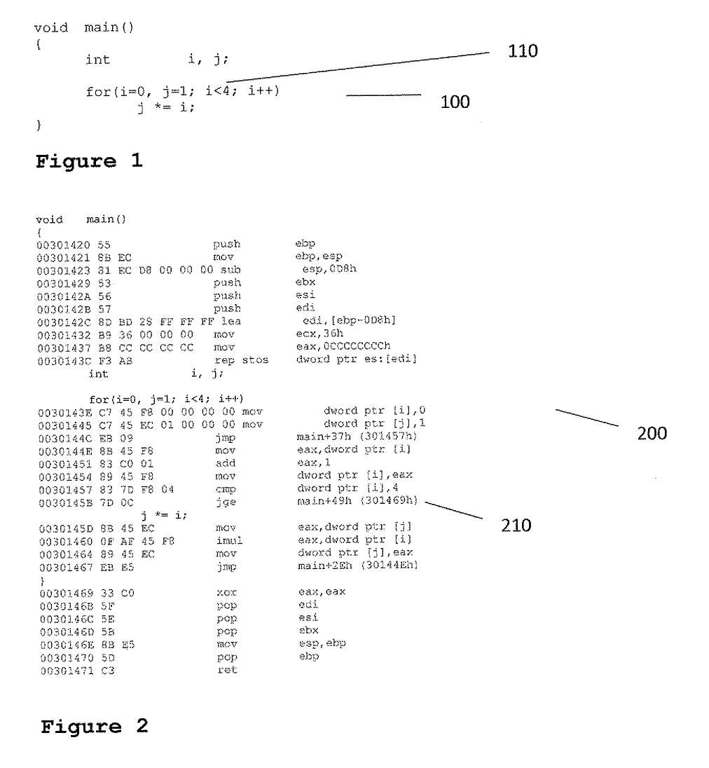

Referring now to the drawings, FIG. 1 shows a very simple program 100, written in C, that calculates 4! (factorial of 4) and assigns it to variable ‘j’. Note that in this simple program we have only a single non-deterministic jump instruction 110, a conditional jump in the “for” loop, testing if i<4. For clarity of exposition, the following FIGS. 2-7 illustrate the instrumentation and recording process only for this simple conditional jump instruction. As explained above, this code can be modified easily to handle other types of non-deterministic jump instructions such as indirect jumps and returns.

FIG. 2 shows the same program with embedded assembler and machine language instructions 200 that were generated by the Microsoft Visual C+H+ compiler. In 210 we can see at code address 30145B the assembler mnemonic (JOE 301469h) and the corresponding machine language bytes (7D 0C) of the conditional jump 110.

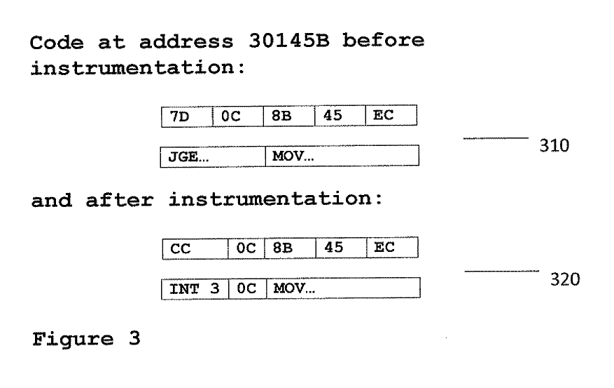

FIG. 3 shows (310) the conditional jump and the following move instruction before instrumentation, and at 320 we see the software recording instruction that overwrites just the byte at address 30145B with CC (INT 3).

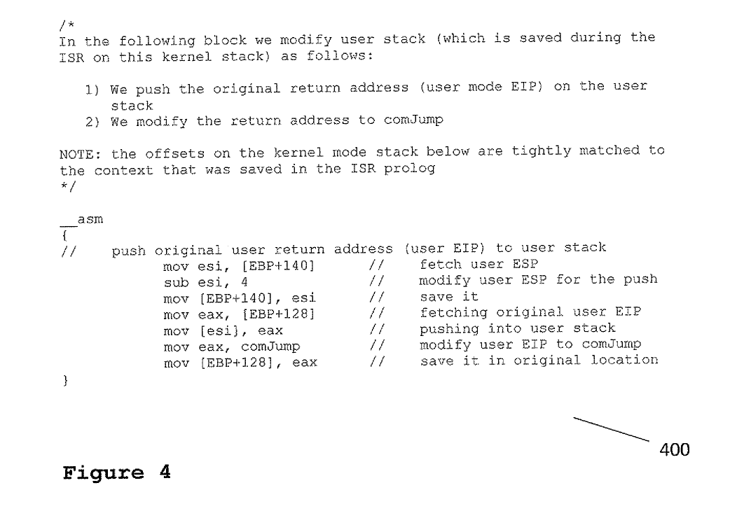

FIG. 4 shows a code snip 400 (in Intel x86 inline assembler code) of the registered ISR (INT 3 or other) with embedded comments showing how we save the original return (from the interrupt) address on the user stack and modify it to return to the ComJump routine which is responsible for the actual recording code. Per this example, the original return address is 30145C (which is the address following the instrumented INT 3).

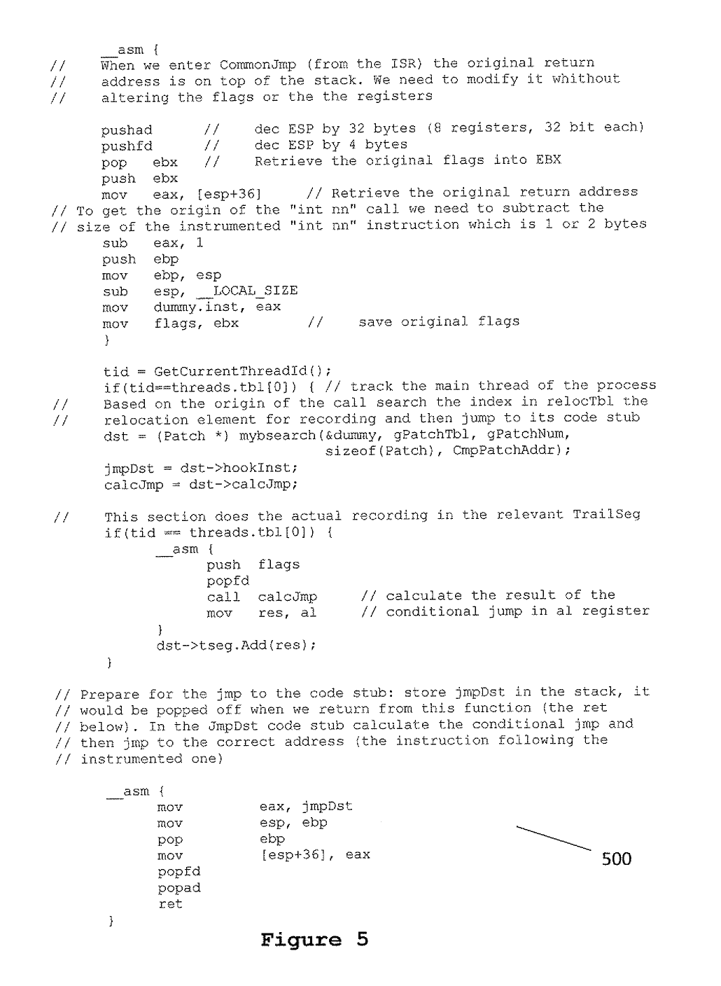

FIG. 5 shows a code snip 500 (in C and Intel x86 inline assembler code) of the ComJump routine with embedded comments. The first step retrieves the original return address and subtracts 1 from the original return address so we retrieve the address of the instrumented instruction 30145B. Then we use this address as a key to search the correct entry in the recording array. Though in this exemplary code we use binary search, any type of search in a sorted or hashed table will work as well. From this structure entry we retrieve a pointer to two code stubs: CalcJmp for calculation of the result of the conditional jump, and jmpDst to jump after recording in order to execute the original non-deterministic jump instruction and then jump to the correct address. Then we do the actual recording of the result of the conditional jump by calling Calcjmp which sets AL register to 0 if the conditional jump was not taken or 1 if the conditional jump was taken and saving the result in the dynamic buffer in the recording structure. Finally we jump to the code stub jmpDst to execute the original instruction and jump to the correct location.

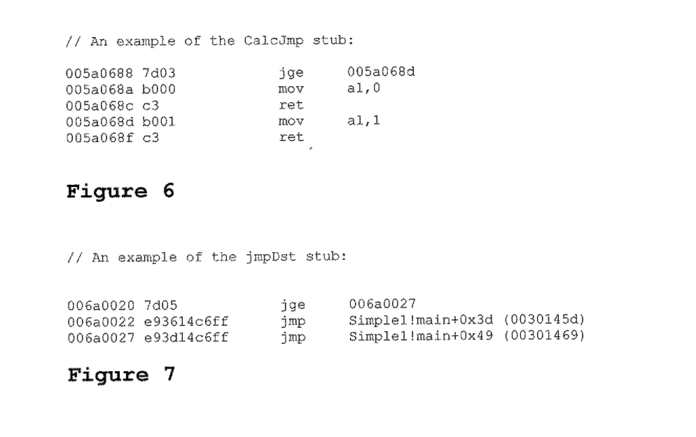

FIG. 6 shows an example 600 of the CalcJmp stub for the sample JOE instruction. Note that as we enter this code the flags are set just as they were before the original instruction. So we just execute the same conditional jump instruction JOE and based on the result set AL register to 0 or 1 and return.

FIG. 7 shows an example 700 of the jmpDst code stub. Note again that the flags are set just as they were before the original instruction so we can execute the same JOE and based on the result we jump to the correct original code. In our example we can see that if the JOE at the stub address 6A0020 didn't branch then we continue to the following instruction at address 6A0022 which unconditionally jumps to original address 30145D. As can be seen in FIG. 2, this address is the instruction that follows the original instrumented JOE instruction 210 at address 30145B. If the branch was taken at the stub address 6A0020 then we continue to 6A0027 and then unconditionally jump to original address 301469 which is the required one, after the “for” loop, as seen in FIG. 2.

The replay phase is simpler then the recording phase, as it is done offline and not in real time. In general, based on the saved track file and the disassembly of the program, we can easily proceed forward to the next instructions in the execution flow, but in order to replay backwards we must pre-process the recorded data.

First we read the track file and the assembly file (if we compiled the program ourselves) or the disassembled code (if we disassembled machine language code) into memory. Now for each entry of the recording array we initiate a zero index n=0. During the execution replay, this index indicates the sequential location in the specific entry of the recording vector. For example, suppose we have a recording entry for a specific conditional jump instruction at some address which was executed 2000 times in a specific recorded session. Now we start the replay process and we reach this instruction for the first time. We increment the entry's index n (so currently n=1). We look up the recorded result of the conditional jump that was reached after n times (in our case n=1), and continue replay accordingly. The next time we reach the same instruction we look up the result for n=2 etc. up to the last time this instruction was recorded when n=2000.

We call the vector of all indices the RSV (Recording/Replay State Vector). The size of the RSV equals the number of entries in the recording array. The RSV is initialized to zeros, and is updated during replay (each time that we pass a non-deterministic jump instruction and retrieve the recorded result) up to the maximum number of times that were recorded per each non-deterministic jump instruction.

Forward replay is started according to the starting address, which is retrieved from the program executable file. Single step forward (i.e. moving to the address of the next instruction) is done according to the assembly file or according to the disassembled code. For each instruction we retrieve its length and proceed to the address of the next instruction. When a non-deterministic jump instruction is reached we look up its result from the recorded buffer and the replay state vector (as explained in the previous paragraph). In this way we can continue rolling forward up to the last recorded instruction. We detect the last recorded instruction easily: as we reach a non-deterministic jump instruction and look up its result, and in case the current index in the RSV is greater than the recorded data we know that we have reached the end of the recorded session. We can further confirm that we have reached the end of the recorded session by verifying that the values of the RSV indices equal their maxima for all of entries of the RSV. If debugging information is available, we can retrieve for each address of an assembly instruction the source file and line number in any high level language (e.g. C, C++, C# etc.) and display the line of the source file in a high level IDE (Integrated Development Environment) like Microsoft's Visual Studio or similar.

Single step backward replay is harder as we cannot know if the current instruction was reached directly from the preceding instruction or if the current instruction was the destination of any sort of jump instruction from some other location in the program code. In order to resolve this problem we build backward execution flow from the existing forward execution flow. This is done by full forward replay as described in the previous paragraph, but each time that we pass any sort of jump instruction (either deterministic or non-deterministic) we build a backward entry for the destination address with the source of this jump. In this way once we finish the forward replay we have a backward recording array, similar to the original (forward) recording array, that has a valid entry for each address of an instruction that was reached (at least once) non-sequentially. During this forward replay we also build the BRSV (Backward Replay State Vector) that will be used to index into the backward recording array in a similar manner to the forward array.

It often is useful to execute the instrumented code twice, and then compare the two records of the execution path off-line by stepping through the two records together. In the absence of non-deterministic bugs in the code being debugged, the two records should be identical. If the two records are not identical, the point at which the two records diverge may be indicative of the presence of a non-deterministic bug in the code being debugged. The corresponding point in the source code should be inspected. Alternatively or additionally, a breakpoint should be set at this point in the executable code so that the execution can be repeated and manual debugging, for example using a standard debugger Graphical User Interface (GUI), can commence at the point of divergence.

Alternatively, this comparative debugging is done on-line. The ISR is modified so that the second execution of the instrumented code also steps through the first record of the execution path. The ISR also is modified to compare the two executions, and to break to the debugger GUI by triggering a standard breakpoint when the two executions diverge.

There are cases in which the first point of divergence of the two executions is not diagnostic of the non-deterministic bug being sought, so that the two executions should be re-synchronized and the second execution should be continued to a later point of divergence that is more likely to be diagnostic of the bug being sought. For example, suppose that a word processing program occasionally crashes while printing a particular page of a particular document. In the first execution, the document was opened in a GUI and scrolled down to the page in question using a mouse, and the page in question was printed successfully. In the second execution, the document is opened in the GUI and keyboard arrows are used to navigate to the page in question. The first point of divergence is at the use of the keyboard arrows instead of the mouse and so is not relevant to a non-deterministic bug associated with the printing of the page.

To handle such cases, “synchronization instructions” are used. The code to be debugged is instrumented with such synchronization instructions at one or more strategic locations such as the entry or exit point of a function, the end of the initialization code, and before and after code segments that involve a GUI. A synchronization instruction resembles the software interrupt instructions that are substituted for the non-deterministic jumps, except that the associated TSR only records the number of times the instruction has been executed. In the off-line comparison of the two executions, the stepping through together of the two records of the execution paths is continued to the first point of divergence after a targeted synchronization instruction has been executed a pre-determined number of times in both executions. In the on-line comparison of the two executions, the second execution breaks to the debugger GUI at the first point of divergence after the targeted synchronization instruction has been executed a pre-determined number of times in both executions. For example, in the case of the wayward word processing program, a synchronization instruction at the entry to the print routine enables comparative debugging despite the two different ways in which the two executions reached the printing of the problematic page. Note that the count up to the pre-determined number of executions of the targeted synchronization instruction could start either at zero, i.e., at the start of the second execution of the instrumented code (if it is known in advance that the first divergence point is insignificant, as in the case of the wayward word processing program), or from the number of times the targeted instruction has been executed when some divergence point is reached and manual or automatic debugging determines that the divergence point is insignificant (if it is not known in advance that some divergences are insignificant).

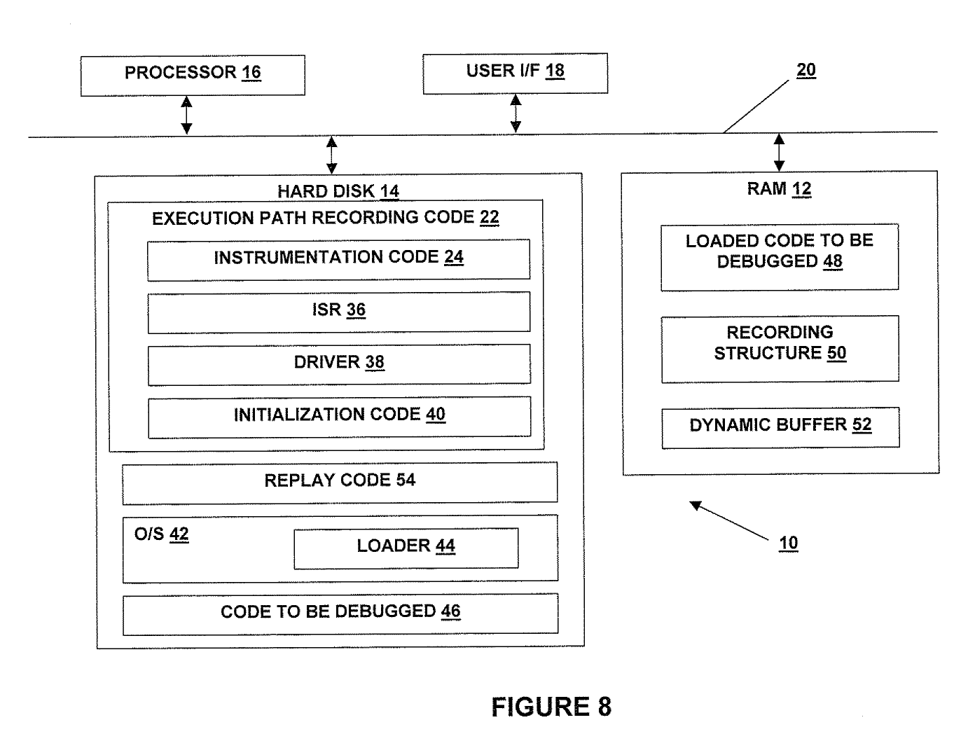

FIG. 8 is a high-level partial block diagram of a computer system 10 set up to debug executable code 46 according to the principles of the present invention. System 10 includes a Random Access Memory (RAM) 12, a hard disk 14, a processor 16 and a user interface 18 communicating with each other via a bus 20. Under the control of an Operating System (OS) 42 stored in hard disk 14, processor 16 executes code that has been loaded into RAM 12 by a loader 44 provided in OS 42. User interface 18 includes standard hardware such as a keyboard, a mouse, a monitor and/or a disk drive, that are used by a user of system 10 to communicate with system 10.

Only the components of system 10 that are germane to the present invention are shown. For example, FIG. 8 does not show the read-only memory for storing boot code that is used to boot system 10.

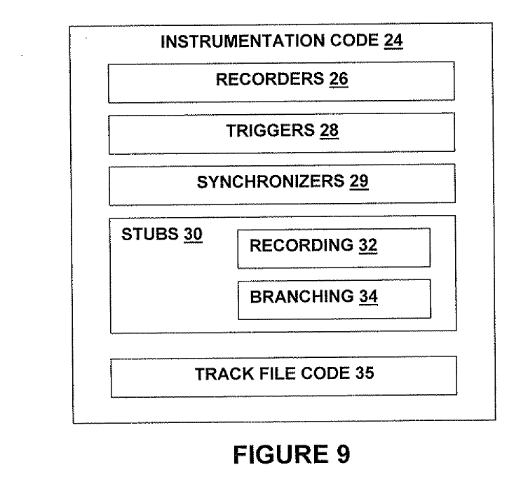

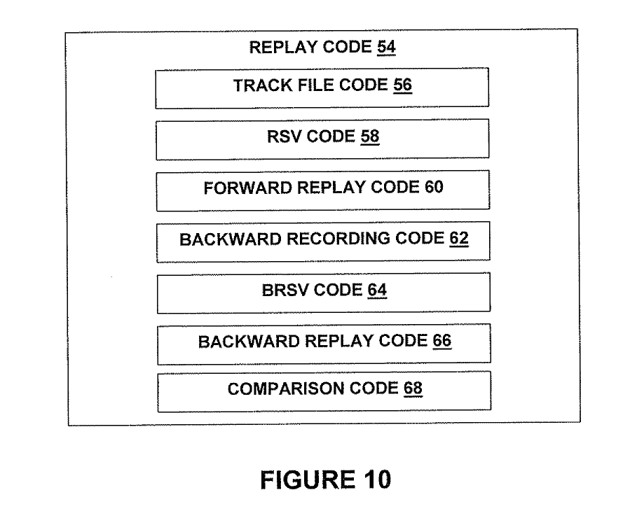

Also stored in hard disk 14 is code 22 for recording execution path of code 46 as described above and code 54 for replaying the execution path of code 46 as described above. Code 22 includes instrumentation code 24 for instrumenting code 46 as described above, an ISR 36, a driver 38 for installing TSR 36 as described above, and code 40 for initializing, in RAM 12, the recording structure 50 described above. FIG. 9 shows instrumentation code 24 in more detail. Instrumentation code 24 includes code 26 for replacing non-deterministic jump instructions of code 46 with recording instructions (that are implemented as software interrupts), code 28 for replacing selected instructions with trigger instructions (that are also implemented as software interrupts) for starting and stopping the recording of the results of non-deterministic jumps, code 29 for replacing selected instructions with synchronization instructions (that also are implemented as software interrupts) for re-synchronizing two execution flow recordings after the two recordings diverge, code 35 for constructing the track file, and code stubs 30 including stubs 32 such as CalcJmp of FIG. 6 for recording the results of non-deterministic jumps and stubs 34 such as jmpDst of FIG. 7 for emulating what the non-deterministic jump instructions of code 46 that were replaced with instrumented interrupt instructions would have done had they not been replaced with instrumented interrupt instructions. FIG. 10 shows replay code 54 in more detail. Replay code 54 includes code 56 for reading the track file, code 58 for constructing the RSV, code 60 for forward replay with reference to the recording array in the track file and with reference to the RSV, code 62 for constructing the backward recording array, code 64 for constructing the BRSV, code 66 for backward replay with reference to the backward recording array and the BRSV, and code 68 for comparing two execution flow recordings and re-synchronizing the two recordings if needed.

Alternatively, recording code 22 and replay code 54 are accessed from another computer system, such as a server of which computer system 10 is a client, that is accessed by computer system 10 via a network such as a LAN or a WAN.

Code 46 can be instrumented off-line in hard disk 14 or on-line after being loaded in RAM 12 as code 48, as described above. Code 40 is used to initialize recording structure 50 in RAM 12. The results of the executions of the non-deterministic jump instructions that are replaced with recording interrupt instructions are stored in a dynamic buffer 52 in RAM 12. After execution of code 48 terminates, the contents of dynamic buffer 52 are compressed and copied to permanent storage, in hard disk 14 and/or in a nonvolatile memory coupled to system 10 at user interface 18.

Hard disk 14 is an example of a computer-readable storage medium having embedded thereon code 22 and code 54. Other examples of such storage media include compact disks and flash disks, or storage media on which code 22 and code 54 are stored separately from computer system 10 on a network to which computer system 10 is connected.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method of monitoring an execution path of executable code that includes at least one non-deterministic jump instruction, comprising the steps of:
(a) storing the executable code in a first machine-readable medium;
(b) only for each non-deterministic jump instruction of at least a portion of the at least one non-deterministic jump instruction:
(i) identifying an address of said each non-deterministic jump instruction, and
(ii) replacing said each non-deterministic jump instruction with a respective recording instruction for
(A) recording a result of each execution of said each non-deterministic jump instruction in a second machine-readable medium, and
(B) emulating said each execution of said each non-deterministic jump instruction,
thereby providing instrumented executable code; and
(c) effecting a first execution of the instrumented executable code.

2. The method of claim 1, wherein said identifying and replacing is effected off-line.

3. The method of claim 1, wherein said identifying and replacing is effected on-line.

4. The method of claim 1, wherein said address of every said non-deterministic jump instruction is identified and wherein every said non-deterministic jump instruction is replaced by said respective recording instruction thereof.

5. The method of claim 1, wherein each said recording instruction is one byte long.

6. The method of claim 1, wherein said identifying includes reading an assembly file of the executable code.

7. The method of claim 1, wherein said identifying includes disassembling the executable code.

8. The method of claim 7, wherein said disassembling is effected on-line.

9. The method of claim 1, wherein said first and second machine-readable media are identical.

10. The method of claim 1, wherein said first and second machine-readable media are different.

11. The method of claim 1, wherein said recording of said result and said emulating of said each execution of said respective non-deterministic jump instruction is effected by an interrupt service routine that is invoked by said recording instructions.

12. The method of claim 11, further comprising the step of:
(d) installing said interrupt service routine.

13. The method of claim 12, wherein said installing is effected using a device driver.

14. The method of claim 1, further comprising the step of:
(d) prior to said effecting of said first execution, setting up, in said second machine-readable medium, a recording structure that includes, for each said non-deterministic jump instruction of said at least portion of the at least one non-deterministic jump instruction:
(i) an address of said each non-deterministic jump instruction,
(ii) a pointer to a buffer in said second machine-readable medium for recording said result of said each execution of said each non-deterministic jump instruction, and
(iii) a pointer to a code stub for emulating said each execution of said each non-deterministic jump instruction;
said recording and said emulating then being effected with reference to said recording structure.

15. The method of claim 1, further comprising the step of:
(d) replacing at least one other selected instruction of the executable code with a trigger instruction.

16. The method of claim 15, wherein said selected instruction is selected from the group consisting of an entry point of a function of the executable code and an exit point of a function of the executable code.

17. The method of claim 1, further comprising the step of
(d) recording, in a third machine-readable medium, said address of each said non-deterministic jump instruction of said at least portion of the at least one non-deterministic jump instruction, along with all results of any said executions of said each non-deterministic jump instruction, thereby providing a first record of the execution path.

18. The method of claim 17, wherein said second and third machine-readable media are identical.

19. The method of claim 17, wherein said second and third machine-readable media are different.

20. The method of claim 17, further comprising the step of
(e) playing said record of the execution path forward.

21. The method of claim 17, further comprising the step of:
(f) playing said record of the execution path backward.

22. The method of claim 21, further comprising the step of:
(g) during said forward playing of the execution path, constructing a backward recording array and a backward replay state vector, said backward playing of said record of the execution path being in accordance with said backward recording array and said backward replay state vector.

23. The method of claim 17, further comprising the step of:
(e) subsequent to said providing of said first record of the execution path, effecting a second execution of the instrumented executable code.

24. The method of claim 23, further comprising the steps of:
(f) recording, in a fourth machine-readable medium, said address of each said non-deterministic jump instruction of said at least portion of the at least one non-deterministic jump instruction, along with all results of any said executions, during said second execution, of said each non-deterministic jump instruction, thereby providing a second record of the execution path; and
(g) comparing said first and second records of the execution path.

25. The method of claim 24, wherein said third and fourth machine-readable media are identical.

26. The method of claim 24, wherein said third and fourth machine-readable media are different.

27. The method of claim 24, further comprising the step of:
(h) inserting, in the executable code, a synchronization instruction for recording, in said first and second records of the execution path, every arrival of said first and second executions at a location in the executable code where said synchronization instruction has been inserted.

28. The method of claim 23, further comprising the step of:
(f) during said second execution, comparing said result of each said execution of each said non-deterministic jump instruction with said first record of the execution path.

29. The method of claim 28, wherein said second execution is stopped when said comparing shows that said result of one said execution of one said non-deterministic instruction during said second execution differs from said result of said one execution of said one non-deterministic instruction during said first execution.

30. The method of claim 28, further comprising the steps of:
(h) inserting, in the executable code, a synchronization instruction for:
(i) recording, in said first record of the execution path, every arrival of said first execution at a location in the executable code where said synchronization instruction has been inserted; and
(ii) counting every arrival of said second at said location in the executable code where said synchronization instruction has been inserted;
and wherein said second execution is stopped when said comparing shows that, starting from an execution of said synchronization instruction a pre-determined number of times by both said first execution and said second execution, said result of one said execution of one said non-deterministic instruction during said second execution differs from said result of said one execution of said one non-deterministic instruction during said first execution.

31. A computer-readable storage medium having computer-readable code embodied on said computer-readable storage medium, the computer-readable code for monitoring an execution path of executable code that includes at least one non-deterministic jump instruction, the computer-readable code comprising:
(a) program code for: only for each non-deterministic jump instruction of at least a portion of the at least one non-deterministic jump instruction:
(i) identifying an address of said each non-deterministic jump instruction; and
(ii) replacing said each non-deterministic jump instruction with a respective recording instruction for:
(A) recording a result of each execution of said each non-deterministic jump instruction, and
(B) emulating said each execution of said each non-deterministic jump instruction.

32. The computer-readable storage medium of claim 31, wherein said recording instruction is one byte long.

33. The computer-readable storage medium of claim 31, wherein the computer-readable code further comprises
(b) program code for an interrupt service routine to which said recording instructions jump for said recording and said emulating.

34. The computer-readable storage medium of claim 33, wherein the computer-readable code further comprises:
(c) program code for a device driver for installing said interrupt service routine.

35. The computer-readable storage medium of claim 31, wherein the computer-readable code further comprises:
(b) program code for setting up a recording structure that includes, for each said non-deterministic jump instruction of said at least portion of the at least one non-deterministic jump instruction:
(i) an address of said each non-deterministic jump instruction,
(ii) a pointer to a buffer for recording said result of said each execution of said each non-deterministic jump instruction, and
(iii) a pointer to a code stub for emulating said each execution of said each non-deterministic jump instruction; and
(c) program code for said code stub.

36. The computer-readable storage medium of claim 31, wherein the computer-readable code further comprises:
(b) program code for replacing at least one other selected instruction of the executable code with a trigger instruction.

37. The computer-readable storage medium of claim 31, wherein said replacing provides instrumented executable code, and wherein the computer-readable code further comprises:
(b) program code for, subsequent to execution of said instrumented executable code, recording said address of each said non-deterministic jump instruction of said at least portion of the at least one non-deterministic jump instruction, along with all results of any said executions of said each non-deterministic jump instruction, thereby providing a record of the execution path.

38. The computer-readable storage medium of claim 37, wherein the computer-readable code further comprises:
(c) program code for playing said record of the execution path forward.

39. The computer-readable storage medium of claim 38, wherein the computer-readable code further comprises:
(d) program code for playing said record of the execution path backward.

40. The computer-readable storage medium of claim 38, wherein the computer-readable code further comprises:
(e) program code for constructing a backward recording array and a backward replay state vector during said forward playing of the execution path.

41. The computer-readable storage medium of claim 37, wherein the computer-readable code further comprises:
(c) program code for comparing two said records of respective execution paths of two executions of said instrumented code.

42. The computer-readable storage medium of claim 31, wherein the computer-readable code further comprises:
(b) program code for replacing at least one other selected instruction of the executable code with a synchronization instruction.
